(19) United States
(12) Patent Application Publication
(10) Pub. No.: US 2010/0230270 A1
(43) Pub. Date: Sep. 16, 2010

(54) MICROWAVE-BASED CONVEYING DEVICES AND PROCESSING OF CARBONACEOUS MATERIALS

(75) Inventors: Jae Seung Lee, Ann Arbor, MI (US); Ram B. Roy, Salisbury, NC (US); Carl A. Everleigh, Raleigh, NC (US); Scott A. Dunbar, Roscoe, IL (US); John C. Carlin, West Berlin, NJ (US); Lennart Hedman, Roscoe, IL (US)

Correspondence Address: WOODCOCK WASHBURN LLP, CIRA CENTRE, 12TH FLOOR, 2929 ARCH STREET, PHILADELPHIA, PA, 19104-2891, US

(73) Assignee: GLOBAL RESOURCE CORPORATION, Mount Laurel, NJ (US)

(21) Appl. No.: 12/570,323

(22) Filed: Sep. 30, 2009

Related U.S. Application Data
(60) Provisional application No. 61/101,462, filed on Sep. 30, 2008.
(60) Provisional application No. 61/109,743, filed on Oct. 30, 2008.

(51) Int. Cl. B01J 19/12; B01J 19/08

(52) U.S. Cl. 204/155; 422/186

(57) ABSTRACT

Disclosed are methods for microwave-based recovery of hydrocarbons and other carbonaceous materials from solid carbon-containing compositions such as tires. Also disclosed are associated apparatuses.

### CROSS REFERENCE TO RELATED APPLICATIONS

This patent application claims the benefit of U.S. patent application Ser. No. 61/101,462, filed on Sep. 30, 2008, and U.S. Patent Application No. 61/109,743, filed on Oct. 30, 2008, the entirety of each application is incorporated by reference herein.

### FIELD OF THE INVENTION

The disclosed invention relates to methods and apparatuses for using microwave radiation. The disclosed invention also relates to methods and apparatuses for decomposing compositions comprising carbonaceous materials, such as petroleum-based materials.

### BACKGROUND OF THE INVENTION

Carbonaceous materials, such as coal, and petroleum-based materials, such as oil, are integral to the world's economy and demand for such fuels and consumer products is increasing. As the demand rises, there is a need to efficiently and economically extract carbonaceous materials to fulfill that demand. As such, it would be advantageous to not only be able to extract carbonaceous materials from the earth, but to also recycle consumer products to recapture those carbonaceous materials.

Worldwide oil consumption is estimated at seventy-three million barrels per day and growing. Thus, there is a need for sufficient oil supplies. Tar sands, oil sands, oil shale, oil cuttings, and slurry oil contain large quantities of oil, however, extraction of oil from these materials is costly and time-consuming and generally does not yield sufficient quantities of usable oil.

Soil contaminated with petroleum products is an environmental hazard, yet decontamination of petroleum-tainted soil is time-consuming and expensive.

Furthermore, it has been estimated that 280 million gallons of oil-based products such as plastics and rubber go into landfills each day in the United States. Systems therefore exist for the recapture and recycling of raw materials from these products, and particularly focus on vehicle tires, whose major components are steel, carbon black, and hydrocarbon gases and oils, which are commercially desirable. Conventional systems employ microwave systems that fill a microwave chamber with attenuated microwave energy, thereby removing hydrocarbon components from the recycled material.

While such systems have proven useful for their intended purpose, a need exists for more efficient methods and apparatuses for the recycling of carbonaceous compositions and for the recovery of carbonaceous materials from composites containing carbonaceous materials.

### SUMMARY

The present invention provides bulk processing assemblies comprising a microwave housing defining an interior microwave chamber defining an infeed end and an outfeed end; a transport assembly operable to deliver feedstock in a direction from the infeed end towards the outfeed end; and at least one microwave antenna disposed in the chamber and configured to direct microwave energy at the feedstock disposed on the transport assembly so as to remove hydrocarbon fluid from the feedstock.

The present invention also provides methods for processing feedstock in a processing assembly including a microwave chamber defining an internal chamber that has an infeed end and an outfeed end, the steps comprising delivering feedstock into the infeed end; transporting the feedstock past at least one microwave antenna; emitting microwave radiation from the microwave antenna directly into the feedstock without attenuating within the microwave chamber; condensing hydrocarbon fluid produced during the emitting step; and removing processed material from the outfeed end.

The general description and the following detailed description are exemplary and explanatory only and are not restrictive of the invention, as defined in the appended claims. Other aspects of the present invention will be apparent to those skilled in the art in view of the detailed description of the invention as provided herein.

### BRIEF DESCRIPTION OF THE DRAWINGS

The summary, as well as the following detailed description, is further understood when read in conjunction with the appended drawings. For the purpose of illustrating embodiments of the present invention, there are shown in the drawings exemplary embodiments of the invention; however, the invention is not limited to the specific methods, compositions, and devices disclosed. In addition, the drawings are not necessarily drawn to scale. In the drawings:

FIGS. 1A, 1B, and 1C are schematic illustrations of a processing assembly constructed in accordance with one embodiment of the present invention;

FIG. 2 shows a double gate assembly of the processing assembly illustrated in FIG. 1A, 1B, including a sectional side elevation view of an upper gate assembly, and a side elevation view of a lower gate assembly;

FIG. 3 is a schematic illustration of a microwave device and control room of the processing assembly, illustrated in FIG. 1, suitable for generating microwaves and propagating the same through waveguides;

FIGS. 4A and 4B are a schematic illustrations of the processing assembly illustrated in FIG. 1A, 1B;

FIG. 5 is a schematic view of a vacuum piping assembly;

FIGS. 6-1(a-f) depicts six different three dimensional views of an embodiment of a vaned microwave antenna;

FIG. 6-2 is a cross-sectional view of a vaned antenna positioned in a processing assembly of the present invention;

FIG. 6-3 is a cross-sectional view of the an upper portion of a vaned antenna configured with respect to a waveguide;

FIG. 6-4 is a three-dimension cross-sectional view of a vaned antenna configured with respect to a waveguide;

FIG. 6-5 is a three-dimension view of the bottom of a vaned antenna to illustrate its interior dimensions; and

FIG. 7 depicts simulation results of the S-parameter magnitude versus microwave frequency.

### DETAILED DESCRIPTION OF ILLUSTRATIVE EMBODIMENTS

The present invention may be understood more readily by reference to the following detailed description taken in connection with the accompanying figures and examples, which form a part of this disclosure. It is to be understood that this invention is not limited to the specific devices, methods, applications, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

As used herein, the term “fluid” refers to gas, liquid, super critical fluid, or any combination thereof

As used herein, the term “carbonaceous” means containing carbon. Carbonaceous materials may contain elements other than carbon too.

One aspect of the present invention provides methods for chemically altering a carbon-containing composition. These methods include altering the chemical structure of at least a portion of the composition by applying microwave radiation comprising at least one frequency component in the range of from about 7.5 GHz to about 8.5 GHz to the composition so as to give rise to at least one carbon-containing molecule being released from the composition.

The energy value of the carbon-containing molecule released from the composition can be at least about 20% greater than the energy of the microwave radiation applied to the composition, at least about 50% greater than the energy of the microwave radiation applied to the composition, at least about 100% greater than the energy of the microwave radiation applied to the composition, at least about 500% greater than the energy of the microwave radiation applied to the composition, or even at least about 700% or about 900% greater than the energy of the microwave radiation applied to the composition.

The microwave radiation suitably includes one or more discrete frequency components. Such components are preferably in the range of from about 7.9 to about 8.3 GHz.

The microwave radiation can also include a range of microwave radiation frequency components. The microwave radiation frequency may vary within the range of frequencies, and may be swept within a range of about +/−0.50 GHz of a single microwave radiation frequency component. In some embodiments, the range of microwave radiation frequency components can include a bandwidth of about 4 GHz. The range of frequency components of said radiation can be in the C-Band frequency range or in the X-Band frequency range. Suitable microwave radiation may also include at least one additional frequency component in the range of from 4.0 GHz to about 12 GHz.

The environment proximate to said composition suitably includes less than about 12 molar % molecular oxygen or less than 12 weight % molecular oxygen, or less than about 8 molar % molecular oxygen, or less than about 8 weight % molecular oxygen. The present inventive method may be performed at a pressure of less than about one atmosphere; without being bound to any particular theory of operation, it is believed that operating at sub-atmospheric pressure facilitates recovery of hydrocarbons from a carbon-containing composition.

Altering includes hydrocarbon cracking, radical formation, cleaving of one or more carbon-carbon bonds, hydrocarbon volatilization, or any combination thereof. Altering includes reducing hydrocarbon molecules having more than about 44 carbons to hydrocarbon molecules having fewer than about 30 carbons, to hydrocarbon molecules having fewer than about 20 carbons, to hydrocarbon molecules having fewer than about 10 carbons, to methane, or to molecular hydrogen.

Altering also includes reducing hydrocarbon molecules having more than about 100 carbons to hydrocarbon molecules having fewer than about 50 carbons, to hydrocarbon molecules having fewer than about 20 carbons, to hydrocarbon molecules having fewer than about 20 carbons, to methane, or to molecular hydrogen.

Altering also includes reducing hydrocarbon molecules having more than about 1000 carbons to hydrocarbon molecules having fewer than about 50 carbons, to hydrocarbon molecules having fewer than about 20 carbons, to hydrocarbon molecules having fewer than about 20 carbons, to methane, or to molecular hydrogen. Polyolefins such as polyethylene and polypropylene are examples of hydrocarbon molecules having more than 1000 carbon atoms.

Altering additionally includes reducing hydrocarbon molecules having more than about 100,000 carbons to hydrocarbon molecules having fewer than about 50 carbons, to hydrocarbon molecules having fewer than about 20 carbons, to methane, or to molecular hydrogen.

The methods also include exposing the carbon-containing composition to an inert gas atmosphere. Suitable inert gases include argon, helium, and other noble gases.

According to the methods, the ambient pressure surrounding the composition is suitably less than atmospheric pressure, or less than about 40 Torr, or less than about 20 Torr, or even less than about 5 Torr.

During the course of the irradiation, the temperature of said composition suitably does not exceed about 1200° C. Depending on process variables and sample materials, the temperature of said composition suitably does not exceed about 700° C., or exceed about 400° C., or exceed about 300° C., or exceed about 150° C.

Suitable carbon-containing compositions usable as feedstock for a processing constructed in accordance with certain aspects of the present invention include material derived from plastics, tires or tire pieces, tar, sand, oil sand, scrap automotive parts, oil cuttings, oil shale, drilling fluid, dredge, sewage, sludge, plant matter, biomass, bunker oil, solvent, commingled recyclables, separated recyclables, or any combination thereof. Gas, oil, fuel, hydrogen, methane, or any combination thereof produced by decomposing suitable carbon-containing compositions, or any alternative carbon-containing composition that can be provided as feedstock to a processing assembly of the type described herein. Such compositions are decomposed to form at least one of oil, gas, steel, sulfur, and carbon black.

An example apparatus and method for processing feedstock is described in pending U.S. patent application Ser. No. 12/138,905, filed Jun. 13, 2008, the disclosure of which is hereby incorporated by reference as if set forth in its entirety herein.

Suitable plastics include, but are not limited to, ethylene (co)polymer, propylene (co)polymer, styrene (co)polymer, butadiene (co)polymer, polyvinyl chloride, polyvinyl acetate, polycarbonate, polyethylene terephthalate, (meth)acrylic (co)polymer, acetal (co)polymer, ester(co)polymer, amide (co)polymer, etherimide (co)polymer, lactic acid (co)polymer, or any combination thereof. Plastics are suitably decomposed by the method to give rise to at least one monomer. Gas, oil, fuel, hydrogen, monomers, and hydrocarbons formed by decomposing plastics according to the claimed method are also included within the present invention.

The applying of the microwave radiation may occur in the presence of a catalyst. Suitable catalysts include carbonaceous material, such as wood char. CaO is also considered a suitable catalysts.

The method also includes the step of collecting the carbon-containing molecules liberated from the composition.

Aspects of the present invention also include methods for removing a carbon-containing fluid from a carbon-containing composition. Such methods include subjecting the composition to microwave radiation for a time sufficient to release the carbon-containing fluid, the microwave radiation comprising at least one frequency component in the range of from about 7.5 GHz to about 8.5 GHz. The microwave radiation suitably includes at least one frequency component in the range of from about 7.9 GHz to about 8.3 GHz. Frequencies outside of this range can also be used, such as in the range of from about 4 GHz to about 18 GHz, as well as frequencies up to about 5 GHz, about 6 GHz, about 7 GHz, about 8 GHz, about 9 GHz, about 10 GHz, about 11 GHz, about 12 GHz, about 13 GHz, about 14 GHz, about 15 GHz, about 16 GHz, or about 17 GHz, and any combination thereof.

The energy value of the carbon-containing molecule released from the composition can be at least about 20% greater than the energy of the microwave radiation applied to the composition, at least about 50% greater than the energy of the microwave radiation applied to the composition, at least about 100% greater than the energy of the microwave radiation applied to the composition, at least about 500% greater than the energy of the microwave radiation applied to the composition, or even at least about 700% or about 900% greater than the energy of the microwave radiation applied to the composition.

The radiation can also suitably include one or more discrete frequency components, in the range of from about 7.9 to about 8.3 GHz. Suitable microwave radiation also includes a range of microwave radiation frequency components; the microwave radiation can be varied within the range of frequency components and can even be swept within a range of about +/−50 MHz of a single microwave radiation frequency component. A suitable range of microwave radiation frequency components includes a bandwidth of about 4 GHz. Suitable ranges also include C-Band frequency range and X-Band frequency range microwave radiation, as well as the frequency range of from about 7.9 GHz to about 8.3 GHz. Microwave radiation suitably includes microwave radiation having at least one frequency component in the range of from about 4 GHz to about 18 GHz, or even from 4 GHz to 12 GHz.

Ambient environments suitable for the claimed methods include environments including less than about 12 molar % molecular oxygen, or less than about 8 molar % molecular oxygen, or less than about 12 weight % molecular oxygen, or less than about 8 weight % molecular oxygen.

The methods suitably include recovering released carbon-containing fluid; such fluids include vapors, liquids, and supercritical fluids. Recovery is suitably performed at a pressure of less than one atmosphere.

The methods also include subjecting the carbon-containing composition to microwave radiation so a to break at least one carbon-carbon bond of the composition.

The methods include altering the carbon-containing composition by hydrocarbon cracking, radical formation, cleaving of one or more carbon-carbon bonds, hydrocarbon volatilization, or by any combination thereof.

Altering can include reducing hydrocarbon molecules having more than about 44 carbons to hydrocarbon molecules having fewer than about 30 carbons, or to hydrocarbon molecules having fewer than about 20 carbons, or to hydrocarbon molecules having fewer than about 10 carbons, or to methane, or even to molecular hydrogen.

The altering also includes reducing hydrocarbon molecules having more than about 100 carbons to hydrocarbon molecules having fewer than about 50 carbons, to hydrocarbon molecules having fewer than about 20 carbons, to hydrocarbon molecules having fewer than about 20 carbons, to methane, or to molecular hydrogen. Altering also includes reducing hydrocarbon molecules having more than about 1000 carbons to hydrocarbon molecules having fewer than about 50 carbons, to hydrocarbon molecules having fewer than about 20 carbons, to hydrocarbon molecules having fewer than about 20 carbons, to methane, or to molecular hydrogen. Altering additionally includes reducing hydrocarbon molecules having more than about 100,000 carbons to hydrocarbon molecules having fewer than about 50 carbons, to hydrocarbon molecules having fewer than about 20 carbons, to methane, or to molecular hydrogen.

The methods include exposing the carbon-containing composition to an inert gas atmosphere; suitable inert gases are described elsewhere herein.

The ambient pressure surrounding the composition is suitably less than atmospheric pressure, or less than about 40 Torr, or less than about 20 Torr, or less than about 5 Torr.

During the course of the irradiation, the temperature of said composition suitably does not exceed about 1200° C. Depending on certain variables, the temperature of said composition suitably does not exceed about 700° C., about 400° C., about 300° C., or about 150° C.

The methods suitably include subjecting the composition to the microwave radiation so as to vaporize at least a portion of the carbon-containing fluid. The method also suitably includes collecting the carbon-containing fluid in at least one collection vessel. The portion that is not vaporized gives rise to residual processed material. When a compositions comprising carbon black is processed, such as materials from tires, the residual processed material comprises carbon black. When such compositions are nearly completely processed, the residual processed material consists essentially of carbon black.

Suitable carbon-containing compositions include tar sands, oil sands, oil shale, slurry oil, oil cuttings, automotive scrap, recycled materials, vegetable matter, dredge, sludge, bunker oil, or any combination thereof The method further includes transporting the carbon-containing fluid at a pressure less than one atmosphere to at least one container to collect the carbon-containing fluid. Where the carbon-containing fluid is a petroleum-based product, the method includes the collecting and transporting of that product at a pressure less than one atmosphere and refining the petroleum-based product.

The method suitably includes carbon-containing compositions where the carbon-containing composition includes less than 1 percent by weight hydrocarbons based on weight composition after the carbon-containing fluid has been released. The methods also includes fuels, monomers, oils, gases, hydrocarbons, methane, and molecular hydrogen produced according to the methods.

Application of the microwave radiation can occur in the presence of a catalyst. Suitable catalysts are described elsewhere herein.

Also disclosed are apparatuses for recovering a carbon-containing fluid from a liquid, viscous, gel, or solid carbon-containing composition. Such apparatuses suitably include a microwave radiation generator capable of supplying microwave radiation characterized as having at least one frequency component in the range of from about 7.5 GHz to about 8.5 GHz; and at least one container or conduit capable of collecting or transporting said carbon-containing fluid from said composition.

The generator is suitably capable of applying microwave radiation characterized as having at least one frequency component in the range of from about 7.9 GHz to about 8.3 GHz. The generator is also suitably capable of supplying microwave radiation comprising at least one frequency component in the range of from about 7.9 to about 8.3 GHz. Suitable generators include klystrons, traveling wave tubes, variable frequency magnetrons, magnetrons, or any combination thereof. Suitable generators are further capable of supplying microwave radiation characterized as having at least one frequency component in the range of from about 7.5 to about 8.3 GHz.

Suitable generators are further capable of varying the components of the supplied microwave radiation frequency. Frequency components include radiation in the C-Band frequency range, radiation in the X-Band frequency range, radiation in the range of from about 7.7 GHz to about 8.3 GHz, and radiation in the range of from about 7.9 GHz to about 8.3 GHz.

The apparatuses also suitably include at least one chamber for holding said composition;. Suitable chambers are closed to the outside atmosphere, and are capable of operating at an internal pressure of less than 40 Torr, at an internal pressure of less than about 20 Torr, or even at an internal pressure of less than about 5 Torr.

Further disclosed are apparatuses for obtaining a carbon-containing fluid from a liquid, solid, gel, or viscous carbon-containing composition; such apparatuses include a microwave radiation generator capable of supplying microwave radiation characterized as having at least one frequency component in the range of from about 7.5 GHz to about 8.5 GHz; and at least one container to collect the carbon-containing fluid.

Suitable microwave generators are described elsewhere herein. Where the microwave generator includes a klystron, the klystron is suitably capable of supplying microwave radiation having a frequency component in the range of from about 7.9 GHz to about 8.3 GHz.

The generator is capable of supplying microwave radiation characterized as having at least one frequency component in the range of from about 7.9 GHz to about 8.3 GHz. The generator is also capable of supplying a microwave radiation characterized as having at least one frequency component in the range of from about 8.0 and about 8.2 GHz. The range of frequency components of said radiation is suitably in the C-Band frequency range, or in the X-Band frequency range.

A suitable apparatus further includes at least one chamber for holding the carbon-containing composition. The chamber is suitably closed to the outside atmosphere, and is suitably capable of operating at an internal pressure of less than about 40 Torr, or at an internal pressure of less than about 20 Torr, or at an internal pressure of less than about 5 Torr.

The apparatus also suitably includes a temperature detector for monitoring the carbon-containing composition or the environment internal to the apparatus. Suitable temperature detectors include infrared instruments, shielded thermocouples, and the like.

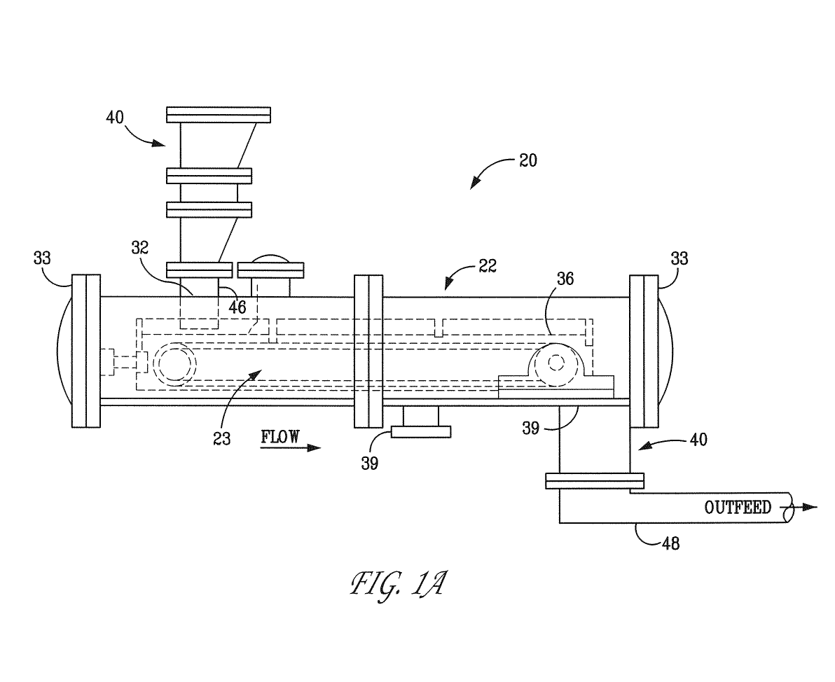

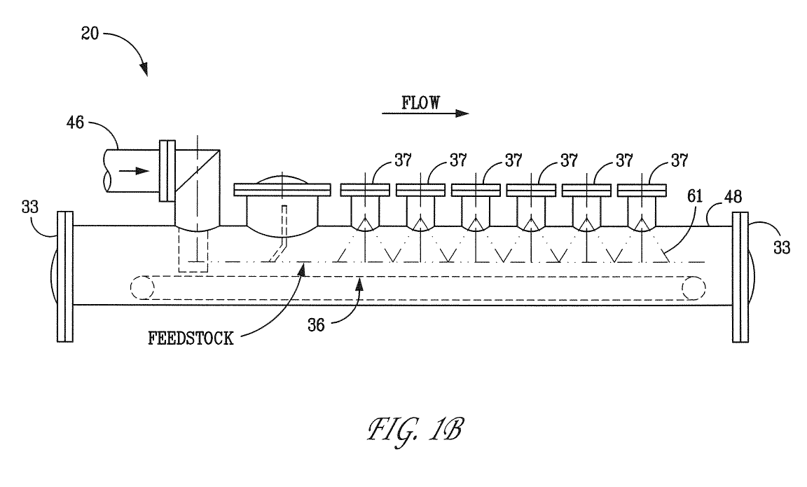

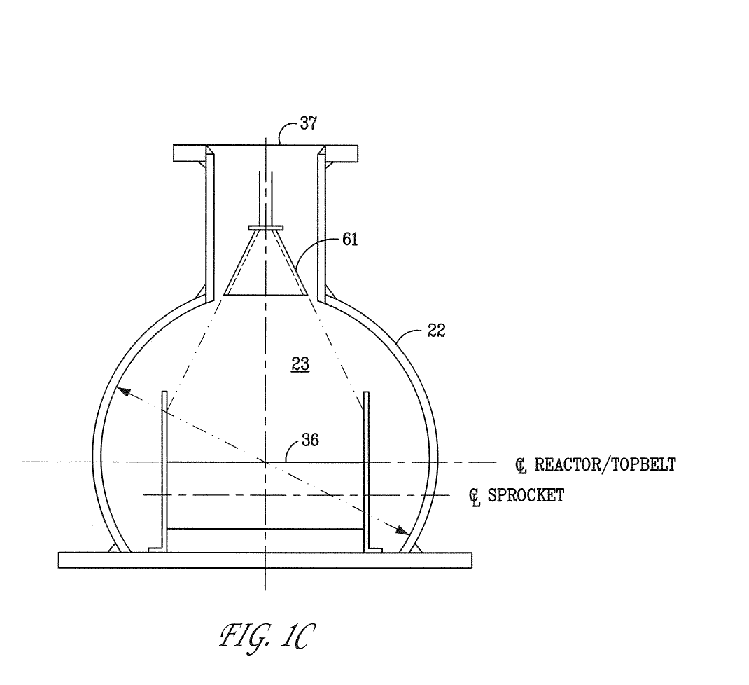

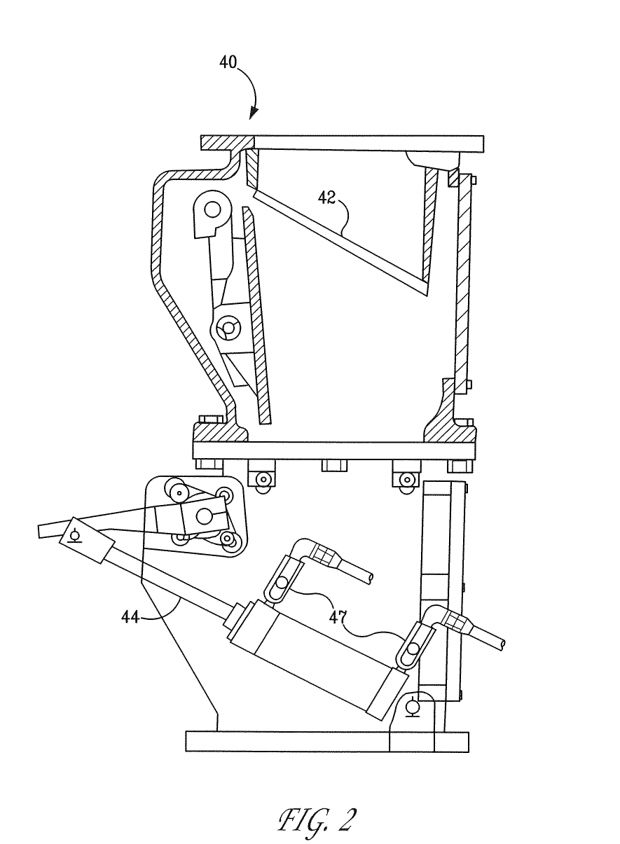

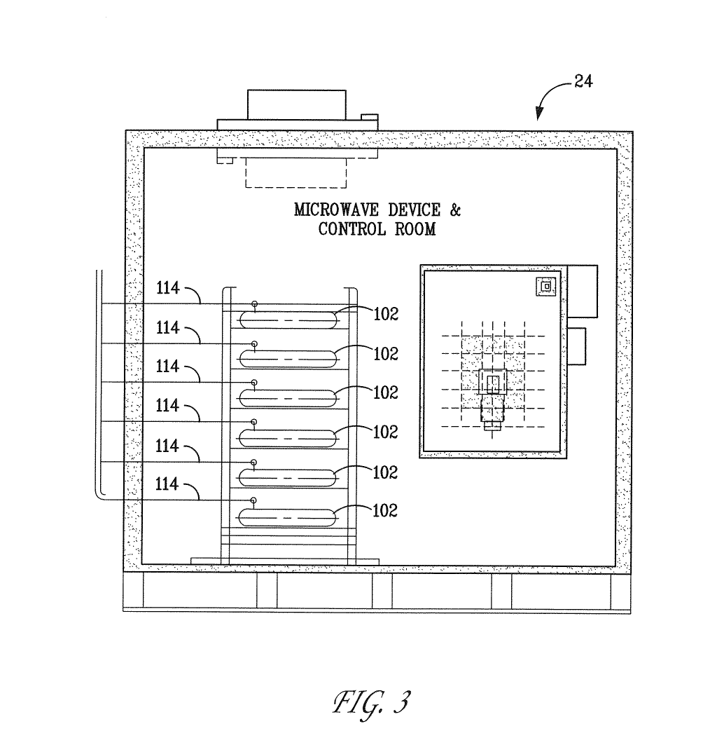

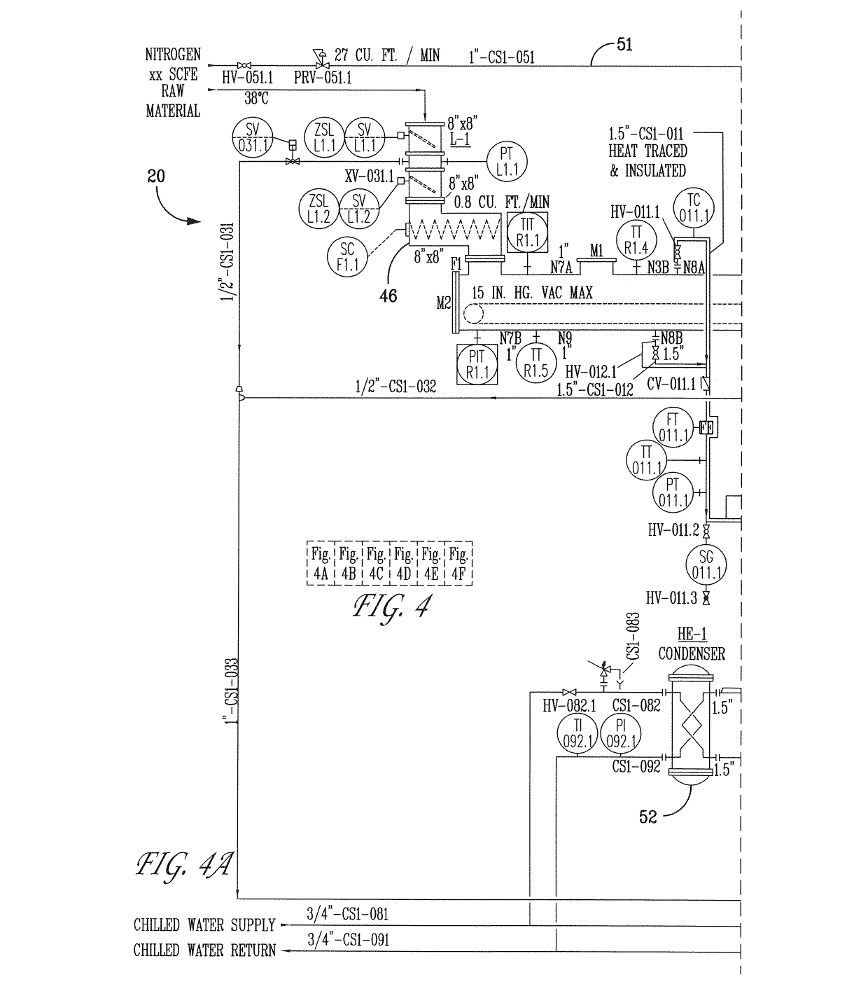

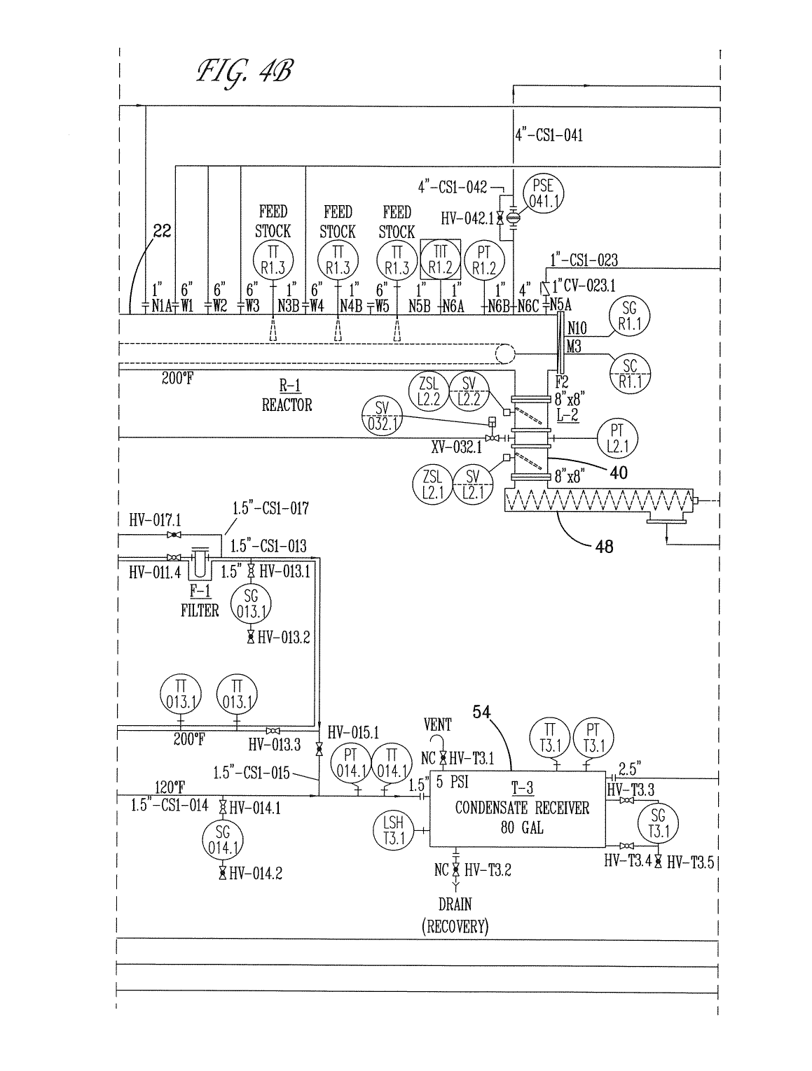

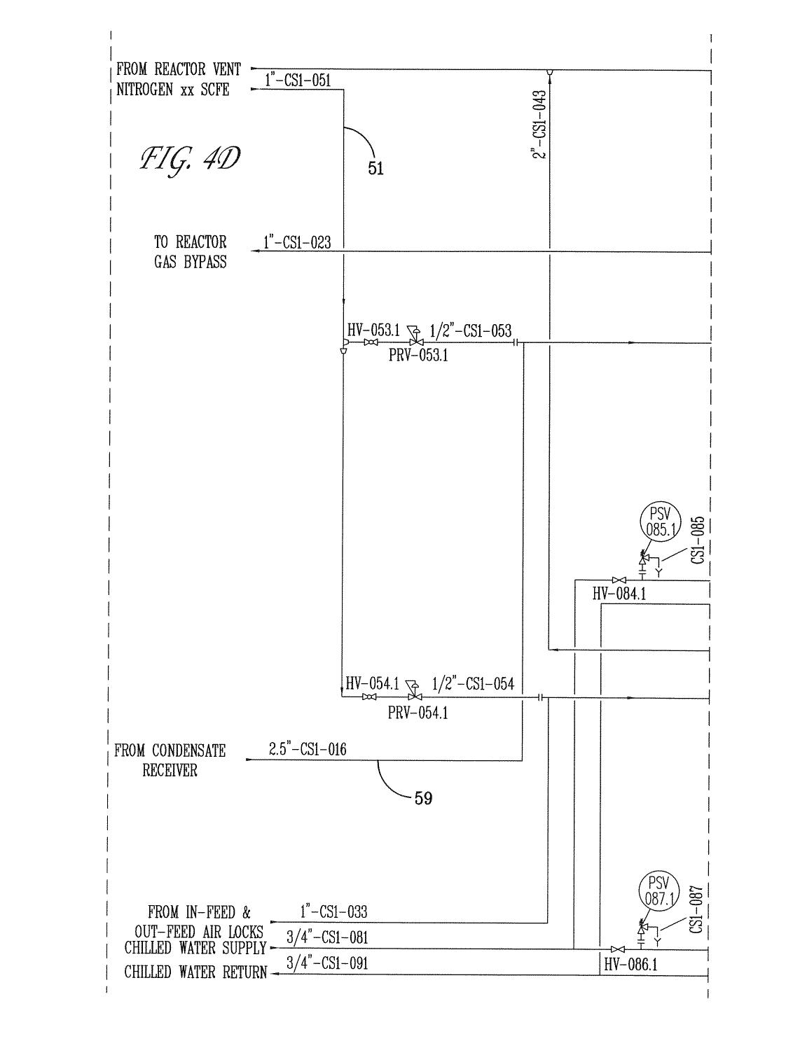

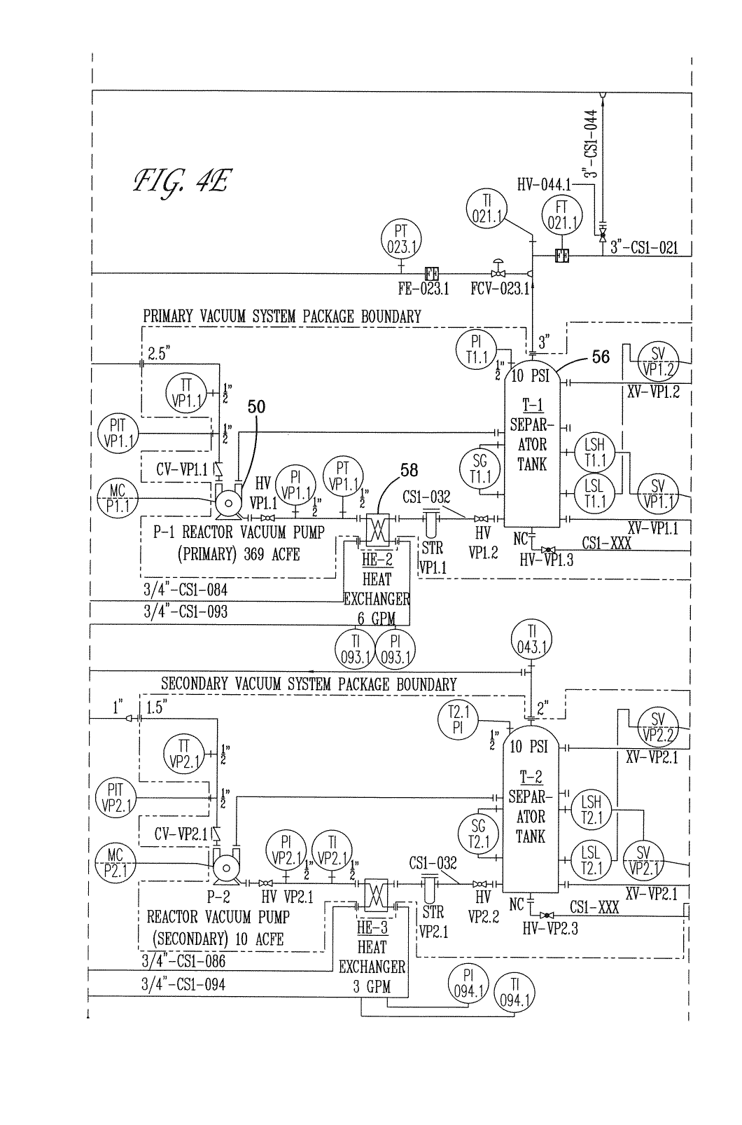

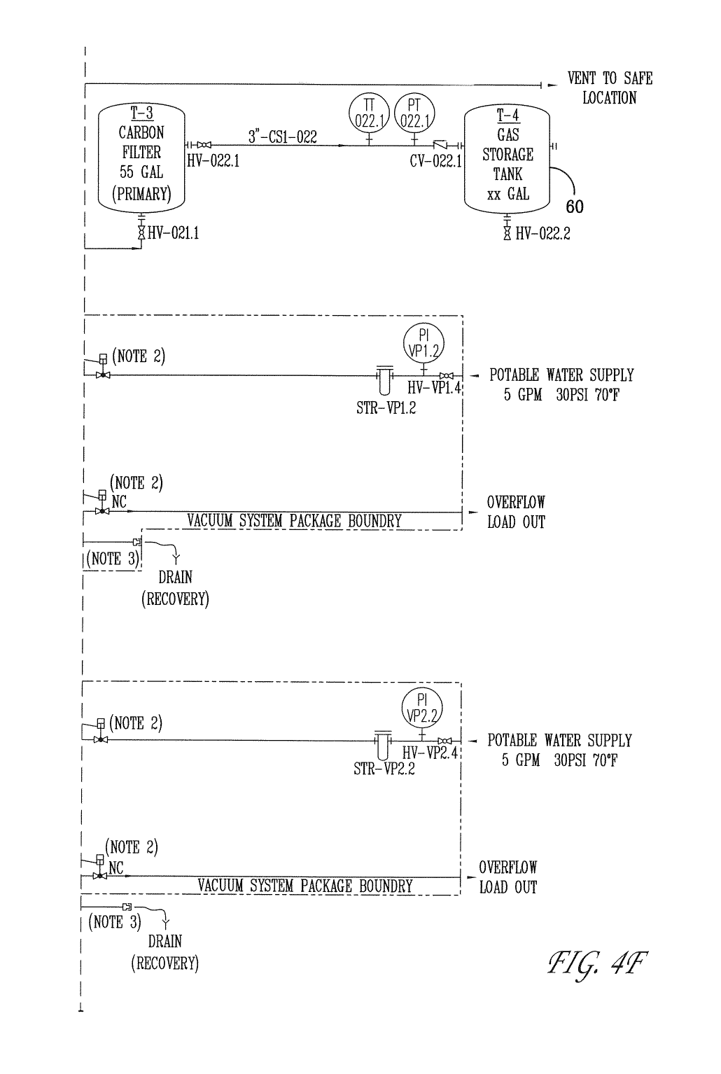

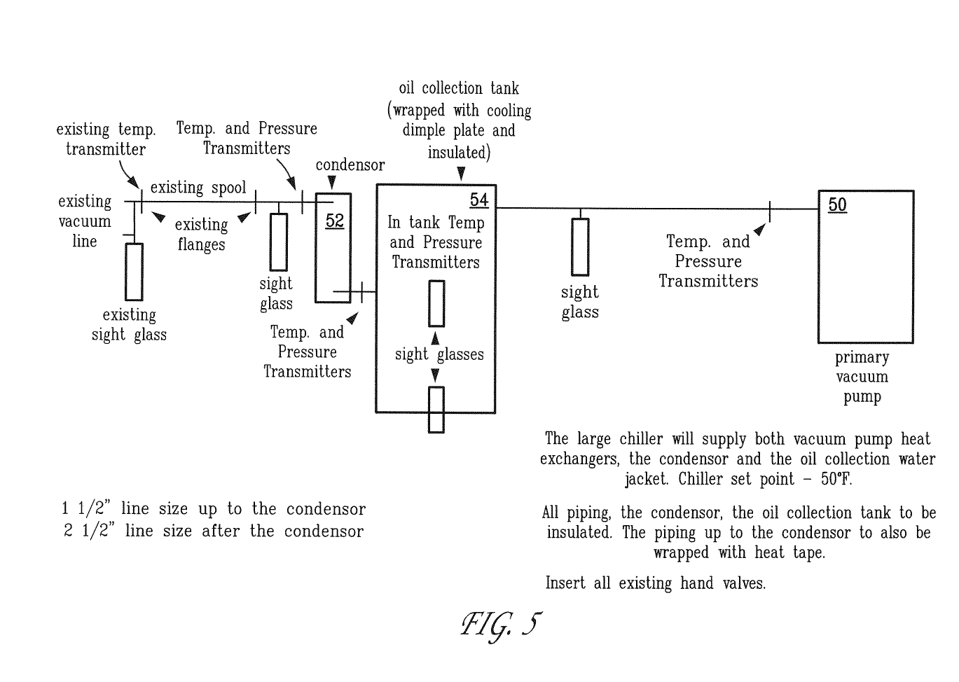

Referring now to the drawings, and in particular FIGS. 1-3, a processing assembly 20 constructed in accordance with one embodiment includes a microwave reactor housing 22 operatively coupled to a power supply unit 24. The reactor housing defines an internal reactor chamber 23. As shown in FIG. 3, the power supply unit 24 includes a plurality of microwave tubes 102 that are operatively coupled to the microwave chamber 23 via a plurality of waveguide assemblies 114. In one aspect of the present invention, the microwave tubes are klystron tubes to produce microwave energy at a fixed frequency ranging from approximately 4 Ghz to approximately 18 Ghz that is suitable for the feedstock being processed such as tires, municipal waste, coal, oil shale, etc. The power supply unit can further include microwave tube generators, high power amplifiers, a master controller module, slave driven power modules, thermal sensors, safety I/O devices for vacuum, interlocks, emergency shut down switches, thermal metrology gear microwave power measurement instruments and a computer control station. As shown in FIG. 4A, a NEMA 4 water resistant electrical motor control panel 25 3 phase control circuits can control the sensors, drives, motor controls, including a PLC control with touch screen HMI diagnostics, I/O racks, rigid conduit with all wire specs color coded, tagged and match-marked for easy identification. Several options for PLC control are commercially available.

Quartz windows can be externally disposed to the microwave housing for transmitting microwave radiation from the microwave waveguides to the microwave antennas. Suitable quartz windows can be connected between the microwave antennas and a corresponding microwave waveguide. The quartz windows are thus capable of maintaining reduced pressure within the microwave housing while transmitting microwave radiation from the microwave waveguides to the microwave antennas.

Quartz windows may further comprise a plurality of choke plates, each choke plate sandwiching one of the quartz windows to absorb reflective microwave radiation. The choke plates can be used to reduce reflective power. For example, a suitable choke plate can be a flange plate that sandwiches the quartz windows which are located along the length of the waveguides 114 and can be located outside of reactor housing item 22. The flange plates can have a deep o-ring type circular groove cut around the peripheral shape of the quartz window. The purpose of the choke plate is to help absorb any reflective RF power to help minimize plasma arcing at the windows.

The processing assemblies may also comprise coax adapters externally disposed to the microwave housing. Suitable coax adapters can be connected between the microwave antennas and a corresponding microwave waveguide. The coax adapters are capable of maintaining reduced pressure within the microwave housing while transmitting microwave radiation from the microwave waveguides to the microwave antennas. Thus, coax adapters can be used in place of quartz windows to reduce plasma arcing. A suitable coax adapter is capable of transmitting microwave signals from the Klystrons 102 into the reactor housing 22 via the waveguide antenna 61. The coax adapter mounts external of the reactor housing 22 and connects via waveguides 114 on both ends. The coax adapter can be used as a transmission line for the microwave signal and transitions the signal from the waveguide, to the coax cable, and back to the wave guide thus allowing microwave signals to enter the process while maintaining vacuum within the system.

Waveguide splitters can also be disposed between a waveguide and at least one of the microwave antennas. Splitting power before windows or coax adapters can be accomplished to reduce arcing potential. Microwave radiation can be split s by adding waveguide splitters to the wave guides 114 after exiting the power supply unit 24. Wave guide splitters split the power from a single waveguide into two parallel wave guide assemblies prior to introducing power into the chamber (FIG. 1C, item 23). The power can be split evenly or unevenly. The reduction of current across each quartz window helps to minimize arcing.

Arcing can also be reduced by purging the waveguides with an inert gas. An inert gas, such as nitrogen, can be introduced into the wave guides 114 between the quartz windows near the power supply 24 and the microwave antenna mounting 37 on the reactor housing 48.

The microwave antennas and the microwave internal reactor chamber are preferably constructed from a ductile metal. Use of a ductile metal, such as copper, for the antenna and surrounding conveyor belt cavity helps to improve thermal and electrical conductivity. For example, the microwave antenna 61 and the surrounding cavity 23 can be constructed from a ductile metal, such as copper to improve electrical and thermal conductivity. It is also preferred that the opening of the microwave antenna is positioned proximate to the transport assembly so that the microwave antenna is disposed proximate to the feedstock. The enables direct absorption of the microwaves by the feedstock and minimizes the creation of multiple modes within the microwave chamber.

As shown in FIGS. 1A-1C, the reactor external housing 22 defines an internal longitudinally elongate internal microwave chamber 23 having an infeed end 32 that receives feedstock product for processing, and an outfeed end 34 that delivers processed feedstock. The housing 22 can be made from a fabricated mild steel, or any suitable alternative material, and can be supported by a structural steel frame or any suitable alternative support.

In an additional embodiment, a stepped conveyor can be used to improve material exposure to the microwave energy. For example, the conveyor 36 shown in FIG. 1B can be tiered to three or more levels thru the process length. The tiering between conveyors, i.e., step down from an upper conveyor to a lower conveyor, allows the material to tumble and provides enhanced material exposure for the microwave process. Suitably, a top conveyor can be positioned under the left two horn antennas 61 as identified in FIG. 1B. A second conveyor can be positioned under the middle two horn antennas. The third conveyor can be positioned under the right two horn antennas 61.

One or more conveyors can also be vibrated to improve material exposure to the microwave energy as it is transported. Vibration of the conveyors can be implemented using two externally driven shafts placed under one or more of the microwave units 61 near or at the top tier of conveyor 36 and at the 2nd tier of the conveyor. The externally driven shafts can include paddles which slap the bottom of the conveyor and cause the material to vibrate as it moves along the length of the conveyor. The vibrating action allows the material to shift around from the top to the bottom of the pile and therefore provides increase exposure of the un-processed material. The vibrating motion also allows the cooked char to shift to the bottom of the feedstock pile so that it does not continue to absorb available energy.

A transport assembly, for example a belt conveyor 36, transports the feedstock within the chamber 23 in a direction from the infeed end 32 toward the outfeed end 34. The belt conveyor 36 can be constructed as a fabricated tight woven steel belt that contains the product and transports it through the reactor housing 22 while the microwave reaction is taking place along the length of the conveyor 36. The conveyor 36 is driven by an externally mounted variable speed electric motor drive package. The housing 22 includes removable covers 33 on each longitudinal end to provide access to the internal chamber 23 for maintenance. The housing 22 is configured to maintain an internal vacuum pressure within the chamber 23. The housing 22 includes microwave antenna mountings 37, a vacuum port 39, temperature and pressure transmitters operable to send signals to the controls in the power supply unit 24, and a rupture disk. The rupture disk is an added safety measure that includes a membrane that is designed to burst if the chamber 23 reaches a predetermined pressure. In one embodiment, the rupture disk is configured to burst in response to a positive pressure, for instance of 5 PSI. Any number of microwave antennas can be provided as desired.

The process can be operated with constant microwave power, varying microwave power, or both. The microwave power level can be varied as feedstock is transferred between the infeed end and the outfeed end. As the feedstock is transferred along conveyor 36 the power levels at the power supplies 24 can be sequentially reduced from load end to unload end of the conveyor to reduce the likelihood of having unabsorbed power which can lead to arcing.

The process can also be operated wherein microwave frequency is varied as feedstock is transferred between the infeed end and the outfeed end. For example, a plurality of frequencies can be used from front to back in the process. As the feedstock is transferred along conveyor 36 the frequencies are sequentially varied at power supplies 24. As the feedstock progresses, suitable microwave frequencies in the range of from 4 to 20 GHz are selected to optimize the absorption rate as the dielectrical and loss tangential properties change through the gasification/reduction process.

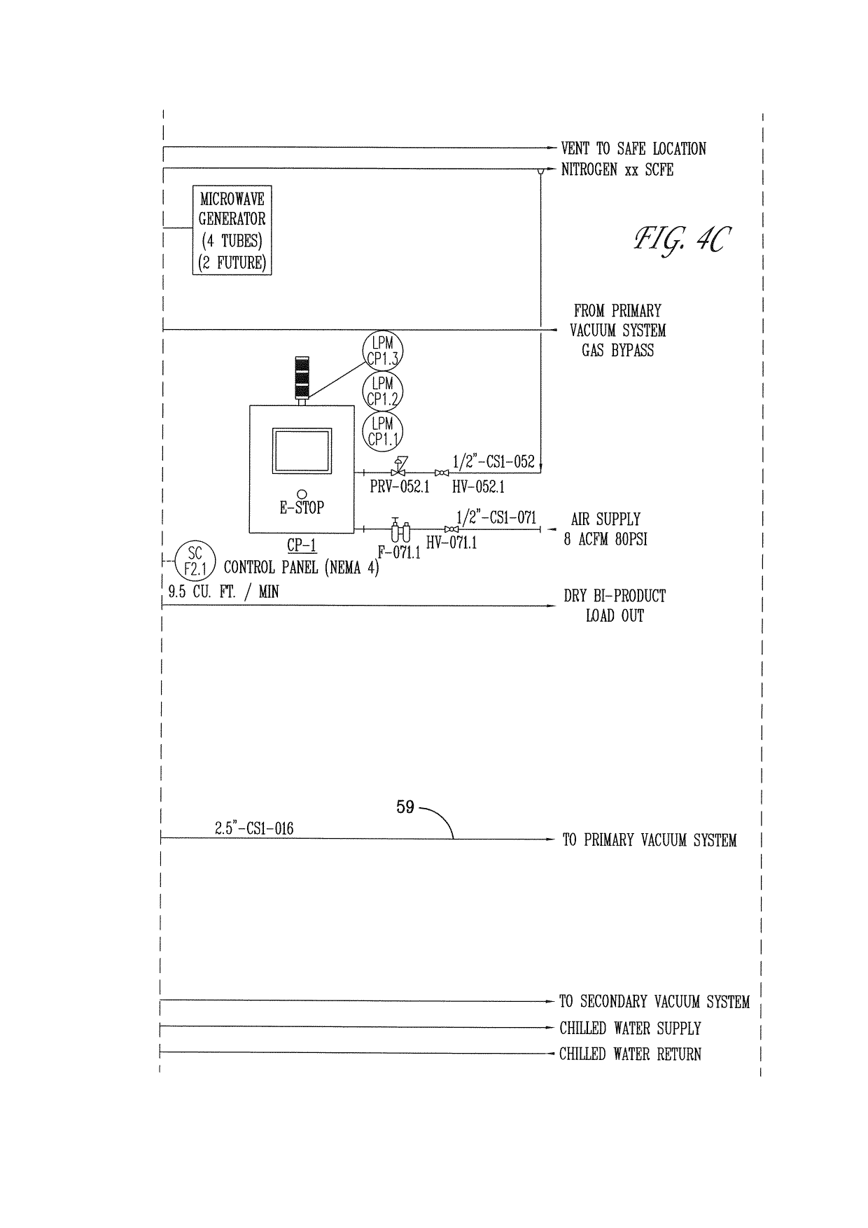

The processing assembly 20 can further include H-Series Double Flap Airlock® Valve double flappergate airlock feed systems 40 of the type commercially available from Plattco Corp., located in Plattsburgh, N.Y. The feed systems 40 include upper and lower gates 42 (the upper gate is shown in FIG. 2) that are driven by a direct coupled air cylinders 44 (the lower cylinder is shown in FIG. 2) that can selectively move the gates between open and closed positions to provide for the transfer of product in and out of the microwave chamber 23 without compromising the vacuum pressure in the chamber 23. The airlock feed systems 40 can include open and closed position switches 47 on both gate valves. A pressure switch can also be provided to ensure proper vacuum pressure within airlock feed systems 40 before opening the gates 42 to the reactor chamber 23.

The airlock feed system 40 disposed at the infeed end 32 of the chamber 23 delivers product to an in-feed screw assembly 46, and the airlock feed system 40 disposed at the outfeed end 34 of the chamber 23 receives processed product via an out-feed screw assembly 48. The in-feed screw assembly 46 comprising a steel frame supporting a schedule 40 carbon steel pipe housing with a hardened helical screw driven by a direct coupled, electric motor to transfer product onto the belt conveyor 36. The outfeed feed screw assembly 48 is similarly constructed, and receives processed product from the belt conveyor 36 and delivers it to the airlock feed system 40 that in turn delivers the product to another transport mechanism for further processing if desired.

During processing, at least a portion of the hydrocarbon fluid can be transported through the microwave antennas. Recirculation of at least a portion of the off gas through the horn antennas and along the processing zone improves energy absorption while maintaining in-process heat and reducing plasma arcing potential. As off gases are removed from the system via the primary vacuum pump (FIG. 4B), some of the gas can be re-circulated back into the process at the microwave antennas 61 and along the length of the chamber 23. This can create pressure which aids in the evacuation of the off gases to minimize power absorption by the hydrocarbon rich off gases.

The feedstock may also be heated prior to being transported past any one of the microwave antennas. A pre-heat cavity can be used to reduce microwave energy requirements. For example, heat from the microwave process or from one or more additional heating sources in cavity 46 can be recirculated prior to the feedstock reaching the main reactor cavity 23. The temperature of the feedstock can be raised from ambient to a temperature closer to the vaporization point of the material to improve the efficiency of the microwave process.

The feedstock can also be mixed with a catalyst prior to emitting microwave radiation from the microwave antenna directly into the feedstock. Use of a catalyst to reduce boiling points and/or improve specific heating characteristics. For example, the application of mixing a catalyst with the feedstock prior to the feedstock entering main reactor cavity 23 can give rise to enhanced vaporization of the carbonaceous material. The catalyst may also improve the thermal characteristics of the carbonaceous material to improve the efficiency of the microwave process.

Referring to FIG. 4B, a vacuum system 59 maintains vacuum pressure throughout the processing assembly 22 thru a liquid-ring pump 50 for 20 in·hg vacuum continuous duty operation. Prior to the vacuum pump, gases are processed thru a condenser 52 and heavy hydrocarbons are collected in a customer supplied containment tank 54. The liquid ring pump can be provided in the form of a full recovery closed loop water system 56 and can include a heat exchanger 58 to reduce the coolant temperature, thereby increasing the vacuum efficiency. Gases that do not condense are then passed along to a gas storage system 60.

Temperature and pressure transmitters can be located at the reactor housing 22 and in the vacuum loop to ensure that changes in temperature and vacuum pressure are displayed on the control panel. Appropriate warning signals (visual and/or audio) can be provided if desired. A pressure switch can be provided in the reactor chamber 23 to provide a back-up to the pressure transmitter. A second temperature transmitter can provided to measure the temperature of the out-feed processed material. Feedback can be interlocked with the system controls and a nitrogen purge to provide emergency shutdown of the reactor. Other points in the system can also have temperature and pressure gauges.

The processing assembly 20 is piped and wired to a common breakpoint on a skid to connect to supplied power, air, water and nitrogen supply. Various locations within the processing assembly 20 are piped for nitrogen flooding 51 in case of vacuum pressure drop within the process.

During operation, feedstock can be provided in a shredded state so that the feedstock is preferably no larger than 3 inch square pieces. The material is fed to the double gate assembly 40 at the infeed end 32 that actuates to move the material to an intermediate position whereby a vacuum line provision removes the oxygen air from the material in-feed chamber of the assembly 40. The lower gate 42 then actuates to position the material dump entry of the in-feed auger screw feeding the reactor chamber 23. The internal reactor environment is maintained at a constant pressure, for instance 508 torr (mm of Hg) (20 inches of Mercury vacuum throughout). Vacuum pressure will lower as gases are produced. The feedstock passes into the microwave reactor chamber 23 onto the internal belt conveyor 36 which moves the material at variable speed under each of the microwave antennas 37, which bombard the feedstock with hydrocarbon-specific RF waves.

Suitable double gate assemblies may include a separate vacuum source operable for maintaining vacuum within the double gate assembly. Use of a higher vacuum level between gate valves helps the gates to remain sealed during processing. For example, vacuum between the gate valves can be maintained with a separate vacuum pump. The lower pressure helps to ensure that the gate assemblies remained sealed each time they are cycled.

The double gate assemblies may further include a spherical gate value operable for maintaining vacuum within the double gate assembly. Gate valves may incorporate a sphere which rolls opened and closed and a diaphragm is expanded during sealing cycles to ensure leak proof operation.

Energy is thus emitted directly into the feedstock via a horn antenna 61, thereby increasing the energy efficiency over systems that attenuate a microwave chamber 23 with microwave energy. While setting up a mode in a cavity by attenuating the microwave energy can result in significant energy efficiencies, directing the energy toward the belt conveyor 36 and thus into the feedstock in accordance with aspects of the present invention can result in a percentage of the energy reaching the feedstock within the range of 60% and 100%, including a range between 60% and 80%, further including between 70% and 100%, and further including a range between 80% and 100%.

The microwave bombardment is absorbed into the material and the hydrocarbons contained in the material are decomposed, gasified, or both, while the vacuum system extracts the expanding gas from the reactor chamber 23 and pipes the extracted gas to a gas or liquid storage tank. The remaining residual materials are conveyed out of the reactor chamber through a reverse process of that of the in-feed whereby the vacuum is released and the slag particulate is discharged onto a customer supplied takeaway belt conveyor.

The system is closed-looped throughout the microwave process and no emissions of gases are introduced into the atmosphere. Additionally, the lack of oxygen in the process can prevent the production of CO₂ and CO, and can further prevent oxidation.

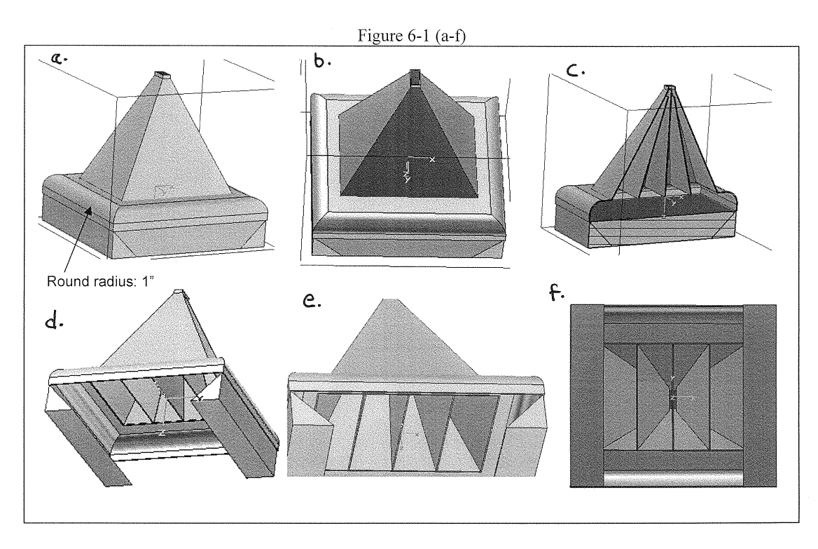

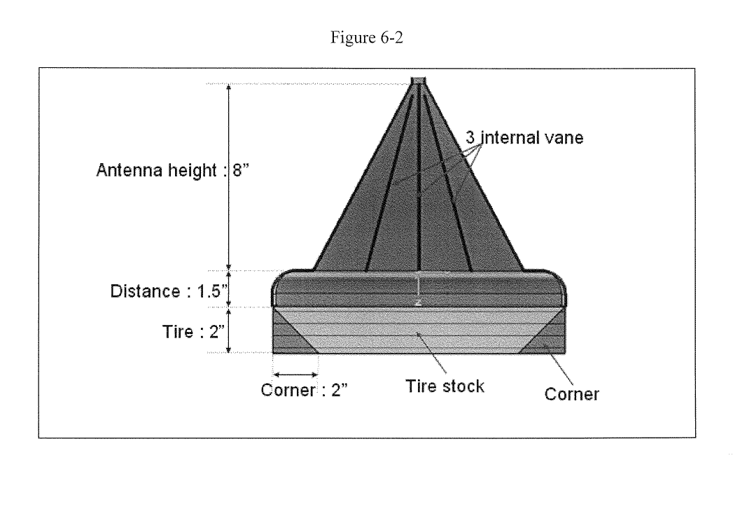

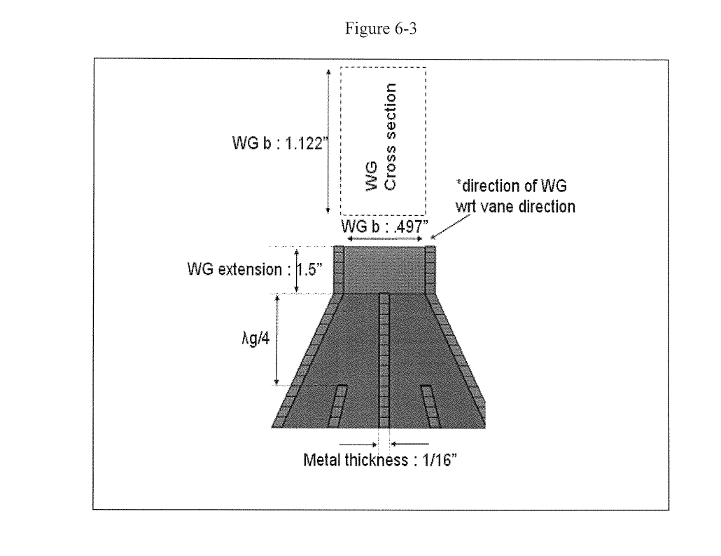

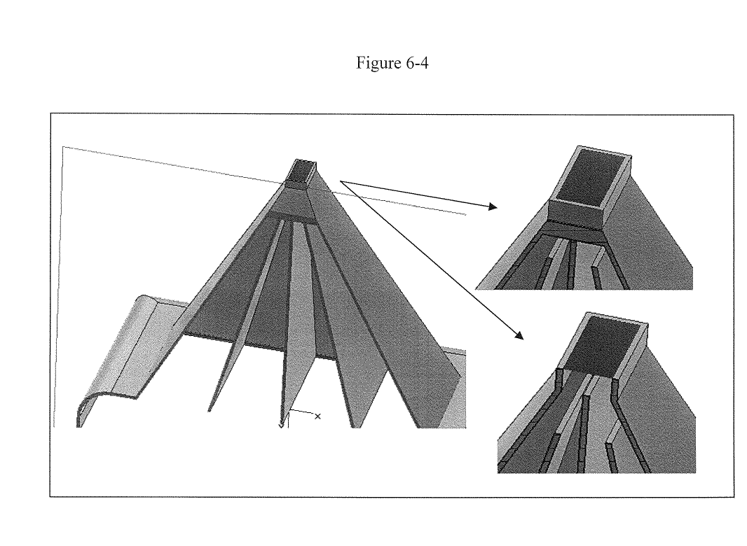

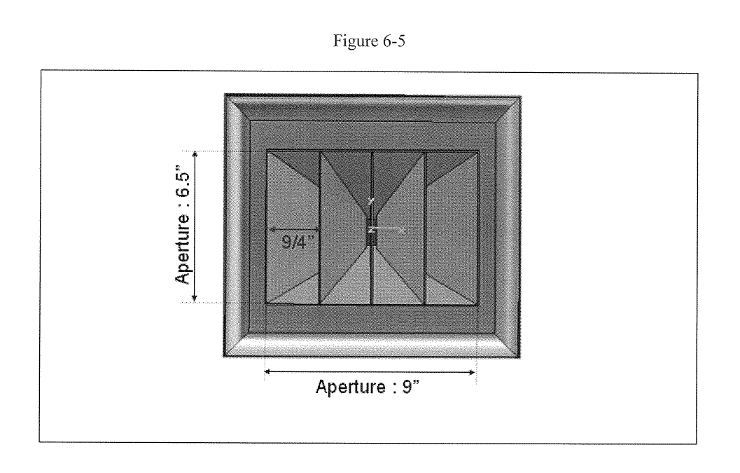

In further embodiments, the microwave antenna may be vaned to provide even power distribution and reduce “hot spots”. One embodiment of a suitable vaned antenna is illustrated in various three dimensional views in FIGS. 6-1(a-f). In FIG. 6-1(a) there is shown the exterior of a vaned horn antenna comprising an opening at the apex for coupling a suitable waveguide 114. Towards the opening of the vaned horn antenna, the edges of the exterior housing are rounded for the purposes of directing microwave radiation to suitable carbonaceous material, such as tire stock, plastics, coal, and the like. The vaned antenna comprises a pyramid-shaped horn antenna comprising three vanes which gives rise to four segmented sub-antennas. The vanes can be regularly or irregularly spaced, but are typically regularly spaced, as depicted in FIG. 6-1(c).

FIG. 6-2 is a cross-sectional view illustrating the exterior dimensions of a suitable vaned horn antennae positioned relative to tire stock. This embodiment is characterized as having an antenna height of about eight inches. Three internal vanes are equally spaced within the horn antenna, giving rise the four-subchambers for emitting microwave radiation. A curved opening comprising rounded edges exterior to the housing is about 1.5 inches in height. Two corner strips attached to the curved opening are approximately two inches in width at a distance opposite the attachment point to the curved opening. A region for the passage of carbonaceous material, such as tire stock, is shown positioned between the conveyor belt (not shown), the two corner strips, and the opening of the antenna.

FIG. 6-3 illustrates a cross-sectional view of the an upper portion of a vaned antenna configured with respect to a waveguide (“WG”). Representative dimensions are provided. In this figure, a central vane is positioned to have an edge starting on the interface between the waveguide and the start of the flare of the vaned horn antenna. The other two vanes are positioned to have an edge starting about ¼ of the guided wavelength of WG. The direction of the waveguide with respect to vane direction is such that the vanes cross the wider of the waveguide. Refer also to FIG. 6-4(a-c), which shows several three-dimensional views of the vane position near the waveguide extension to the antenna. In this example, all sheet metal is 1/16 inch, and waveguide extension is 1.5 inch. Other dimensions can readily be implemented by one of ordinary skill in the art.

FIG. 6-5 is a three-dimension view of the bottom of a vaned antenna to illustrate its interior dimensions of the aperture for emitting microwave radiation. In this example, the aperture is provide in a rectangular configuration having interior dimensions about 9 inches by 6.5 inches, measured according to the interior of the horn antenna. Other dimensions can readily be implemented by one of ordinary skill in the art. Carbonaceous material such as tire stock can be typically transported along the shorter dimension, i.e. the traveling direction is in line with the direction of the direction of the vanes. At the aperture of this vaned antenna, the vanes are equally spaces, therefore the segment antenna is 6.5 inches×9/4 inches.

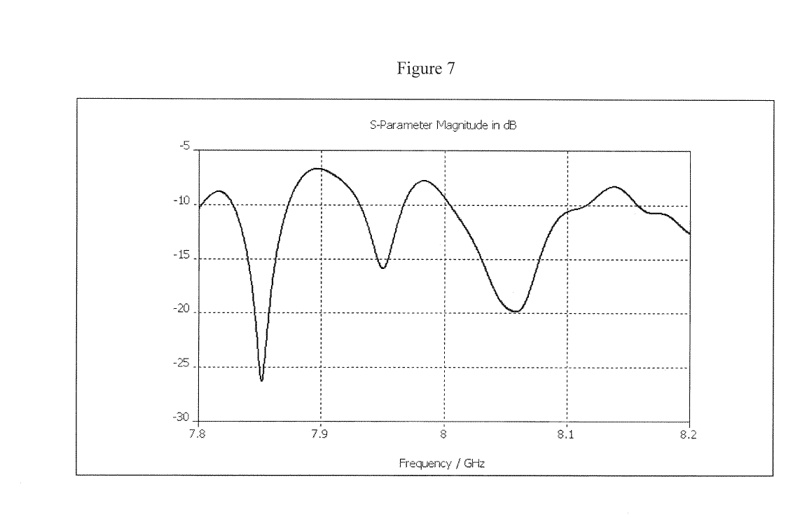

Simulation results of the vaned horn antenna depicted in FIGS. 6-1 to 6-5, when coupled to a 3000 watt microwave source operated at about 8 GHz gives rise to a Specific Absorption Rate (SAR) of about 1880 W/Kg for typical tire material. Simulation results of the S-parameter magnitude versus microwave frequency is illustrated in FIG. 7. These results indicate that between 7.8 and 8.2 GHz, the SAR varies substantially with frequency as illustrated by a number of maximum and minimum values.

It should be appreciated that the embodiments described herein have been provided by way of example, and the scope of the present invention is not intended to be limited to the embodiments described herein. In order to apprise the public of the scope of the present application, the following claims are presented:

What is claimed:

1. A bulk processing assembly comprising:
a microwave housing defining an internal microwave chamber defining an infeed end and an outfeed end;
a transport assembly operable to deliver feedstock in a direction from the infeed end towards the outfeed end; and
at least one microwave antenna disposed in the internal microwave chamber and configured to direct microwave energy at the feedstock disposed on the transport assembly so as to remove hydrocarbon fluid from the feedstock.

2. The processing assembly as recited in claim 1, further comprising a double gate assembly disposed at the infeed end operable to receive the feedstock, place the feedstock under vacuum, and deliver the feedstock under vacuum to the infeed end of the microwave chamber.

3. The processing assembly as recited in claim 2, further comprising a screw assembly connected between the infeed end and the double gate assembly.

4. The processing assembly as recited in claim 1, further comprising a double gate assembly disposed at the outfeed end operable to receive processed feedstock under vacuum, seal the received processed feedstock from the microwave chamber, and deliver the processed feedstock.

5. The processing assembly as recited in claim 4, further comprising a screw assembly connected between the outfeed end and the double gate assembly.

6. The processing assembly as recited in claim 1, further comprising a vacuum system configured to maintain a vacuum pressure in the chamber.

7. The processing assembly as recited in claim 6, wherein the vacuum system comprises a conduit coupled to the chamber for the removal of fluid emitted from the feedstock.

8. The processing assembly as recited in claim 7, wherein the vacuum system draws the emitted fluid through a condenser for the removal of heavy hydrocarbons.

9. The processing assembly as recited in claim 8, further comprising a gas storage system for storing gasses in the fluid that do not condense.

10. A method for processing feedstock in a processing assembly including a microwave chamber defining an internal chamber that has an infeed end and an outfeed end, the steps comprising:
delivering feedstock into the infeed end;
transporting the feedstock past at least one microwave antenna;
emitting microwave radiation from the microwave antenna directly into the feedstock without attenuating within the microwave chamber;
condensing hydrocarbon fluid produced during the emitting step; and
removing processed material from the outfeed end.

11. The method as recited in claim 10, wherein the delivering step comprises placing the feedstock under vacuum;

12. The method as recited in claim 10, wherein the removing step further comprises receiving the feedstock under vacuum, and sealing the received feedstock from the microwave chamber.

13. The method as recited in claim 10, further comprising the step of maintaining vacuum pressure in the microwave chamber.

14. The processing assembly as recited in claim 1, wherein the transport assembly further comprises three or more tiered levels.

15. The processing assembly as recited in claim 1, wherein the transport assembly further comprises a vibrating mechanism.

16. The processing assembly as recited in claim 1, wherein the microwave antennae comprises a plurality of internal vanes.

17. The processing assembly as recited in claim 1, further comprising coax adapters externally disposed to the microwave housing, the coax adapters connected between the microwave antennas and a corresponding microwave waveguide, the coax adapters capable of maintaining reduced pressure within the microwave housing while transmitting microwave radiation from the microwave waveguides to the microwave antennas.

18. The processing assembly as recited in claim 1, further comprising quartz windows externally disposed to the microwave housing, the quartz windows connected between the microwave antennas and a corresponding microwave waveguide, the quartz windows capable of maintaining reduced pressure within the microwave housing while transmitting microwave radiation from the microwave waveguides to the microwave antennas.

19. The processing assembly of claim 18, further comprising a plurality of choke plates, each choke plate sandwiching one of the quartz windows to absorb reflective microwave radiation.

20. The processing assembly as recited in claim 1, further comprising a waveguide splitter disposed between a waveguide and at least one of the microwave antennas.

21. The method of claim 10, wherein microwave power level is varied as feedstock is transferred between the infeed end and the outfeed end.

22. The method of claim 10, wherein microwave frequency is varied as feedstock is transferred between the infeed end and the outfeed end.

23. The processing assembly of claim 2, wherein the double gate assembly comprises a separate vacuum source operable for maintaining vacuum within the double gate assembly.

24. The processing assembly of claim 2, wherein the double gate assembly comprises a spherical gate valve operable for maintaining vacuum within the double gate assembly.

25. The method of claim 10, further comprising waveguides for transmitting microwave radiation to at least one of the microwave antennas, the waveguides being purged with an inert gas to minimize arcing.

26. The processing assembly as recited in claim 1, wherein the microwave antennas and the internal microwave chamber are constructed from a ductile metal.

27. The method of claim 10, wherein at least a portion of the hydrocarbon fluid is transported through the microwave antennas.

28. The method of claim 10, wherein the feedstock is heated prior to being transported past any one of the microwave antennas.

29. The method of claim 10, wherein the feedstock is mixed with a catalyst prior to emitting microwave radiation from the microwave antenna directly into the feedstock.

30. The method of claim 10, wherein the processed material comprises carbon black.

31. The method of claim 10, wherein the processed material consists essentially of carbon black.

32. The processing assembly of claim 1, wherein the microwave antenna is positioned proximate to the transport assembly.

33. The method of claim 10, wherein the microwave antenna is disposed proximate to the feedstock.
